(19) United States
(12) Patent Application Publication
(10) Pub. No.: US 2026/0267696 A1
(43) Pub. Date: Sep. 10, 2026

(54) SYSTEMS AND METHODS OF DETERMINING CONTEXTUAL INFORMATION AND ACTIONS FOR AGENTS IN APPLICATIONS FOR COMPUTATIONAL SYSTEMS

(71) Applicant: Salesforce, Inc., San Francisco, CA (US)

(72) Inventors: Ian Frosst, Ontario (CA); Maxwell H. Ebb, Cambridge, MA (US); Bharath K. Krishnan, Cambridge, MA (US); Alex Kieu, Boston, MA (US)

(21) Appl. No.: 19/069,537

(22) Filed: Mar. 4, 2025

(51) Int. Cl. G06F 9/50

(52) U.S. Cl. CPC G06F 9/5027

(57) ABSTRACT

Systems and methods are provided for determining an action to be taken by an agent based on an interaction with a user. A data model may be received to determine one or more data sources to generate context. A prompt may be generated to determine relevant information for the agent for the interaction based on an action for an agent and/or a directive for the agent based on the data model. The generated prompt may be transmitted to a large language model (LLM) system communicatively coupled to the server. Context data may be retrieved for one or more first objects from the one or more data sources based on a received response from the LLM system based on the transmitted prompt. At least a first action may be determined for the agent for the interaction based at least in part on the retrieved context data which is used as grounding.

### BACKGROUND

Currently, an agent for an application is configured to perform specific tasks, but such agents do not utilize outside information provide context for an interaction and perform the task based on the context.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-3 show an example method of determining contextual information and actions for agents in applications according to implementations of the disclosed subject matter.

FIGS. 4A-4B show an example system and workflow of determining contextual information and agent actions according to implementations of the disclosed subject matter.

FIG. 5 shows an example computer system to perform the example methods of FIGS. 1-3, and the workflow and/or system of FIGS. 4A-4B according to implementations of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Agents in an application may make decisions and take actions within the application, by interacting with various parts of an application to perform tasks. In application interaction, “agents” may refer to software entities that autonomously determine their environment, make decisions, and take actions within an application. That is, agents may essentially act on behalf of a user and/or a computing system, and may communicate with other agents to achieve a goal. Agents may act as virtual assistants and/or automated systems that interact with one or more parts of an application to perform tasks without direct human intervention.

It is desirable to provide the agents with information about the interactor that may be pertinent to the goals of and options available to the agent. As the amount of data available within an application implementation grows, it may be difficult to determine what information may be relevant to the agent. It is typically not feasible to include all known information to the agent, as there may be scale and/or performance limitations in doing so. Implementations of the disclosed subject matter may determine what information about the interactor is likely to be relevant for an agent. By doing this, implementations of the disclosed subject matter may provide a personalized and/or scalable solution to providing agents with relevant information.

Implementations of the disclosed subject matter may use a large language model (LLM) to analyze an available data model, and determine what information is likely to be pertinent to a particular agentic interaction. The pertinent information for the interaction may be retrieved from one or more sources that are determined to be most appropriate. This arrangement may provide a personalized and/or scalable implementation for providing relevant data to agents for performing a task.

In some implementations of the disclosed subject matter, a planner service may be invoked to determine what action service may be taken by the agent. The planner service may invoke a request to a personalization context summarizer. Based on the actions available to the agent, the personalization context summarizer may retrieve a data model to determine what information is available to generate context for the interaction. A prompt may be generated from the available data, and may be transmitted to a large language model (LLM) system to determine what information is relevant based on the agent set of actions and directives. The personalization context summarizer may retrieve the relevant data (e.g., one or more objects from one or more data sources) based on the response from the LLM system. One or more may be determined for the agent based on the retrieved data. The planner service uses the context data as grounding when selecting an action for the agent. As used throughout, grounding may be the ability to connect model output to verifiable sources of information, which may reduce and/or eliminate the chance of the LLM inventing content. That is, implementations of the disclosed subject matter may provide the agents with information about the interactor that may be pertinent to the goals of and options available to the agent.

When an agent is establishing next steps for a given utterance and/or interaction with a user, there may be one or more actions available to the agent, each having information detailing needs and/or intent. When coupled with a data and/or metadata model, implementations of the disclosed subject matter may determine what information in the data model is most relevant to the agent's needs when interacting with the user in the application. That is, metadata for a data ecosystem that may be associated with an application may be used to establish context. For example, context for an agent of an application may be established based on a set of goals.

If no data exists for the object identified by the LLM, the personalization context summarizer may determine the next best set of data and/or objects. In some implementations, if the data model which describes the actions for the agent is cached, the personalized context summarizer may proceed to directly retrieve the relevant data and transmit it to the planner service. In some implementations, metadata may be available that describes the data available, and may be used to ensure that appropriate information is included, and information that is not applicable for the purpose of the agent is not included.

With current applications systems that include agents, context for grounding is generally established based on the utterances and/or text of the user involved in an exchange with an agent, the instructions available to the agent, and/or a record identifier (i.e., record ID) for information being viewed. While this information may be useful, it typically does little to assist agents in considering the unique characteristics and/or circumstances of the user.

Implementations of the disclosed subject matter improve the quality of contextual information provided to agents. Such implementations may provide a personalized and/or scalable implementation for providing relevant data to agents for performing a task. The disclosed subject matter provides improvements over present systems where agents have defined tasks, and do not utilize outside information provide context for an interaction and perform the task based on the context.

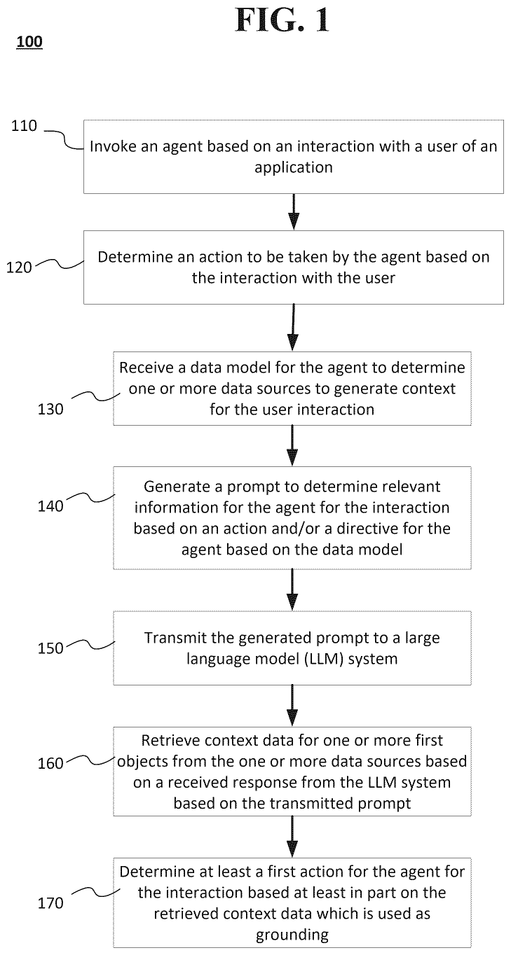

FIGS. 1-3 show an example method 100 of determining contextual information and actions for agents in applications according to implementations of the disclosed subject matter.

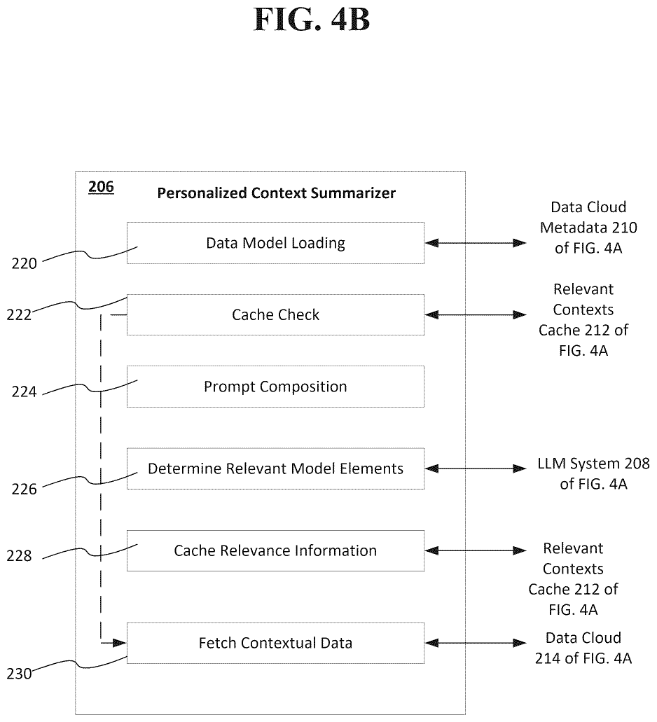

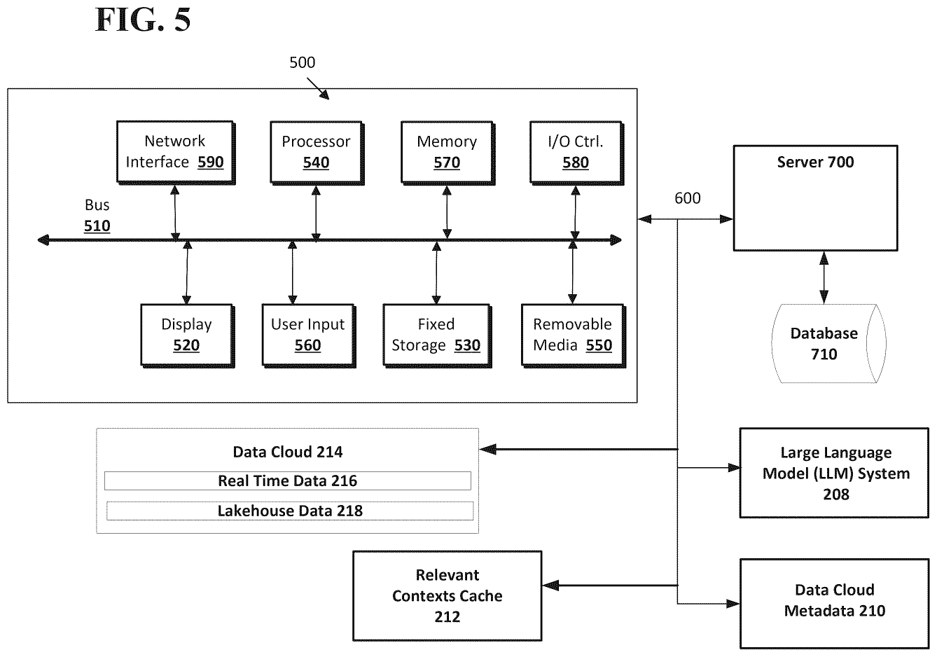

At operation 110, a server (e.g., server 700 shown in FIG. 5, which may include the personalized context summarizer 206 shown in FIG. 4A) may invoke an agent based on an interaction with a user of an application. For example, a user of computer 500 may interact with an application provided by computer 500, server 700, and/or another server communicatively coupled to the computer 500 via communications network 600 shown in FIG. 5. Based on the user's interaction with the application, an agent may be invoked by the application.

At operation 120, the server may determine an action to be taken by the agent based on the interaction with the user. As part of this determination, the server may receive a data model for the agent to determine one or more data sources to generate context for the user interaction at operation 130. As described below, the data sources that may be available for the agent may be determined, and may be used by method 100 to determine a context for the agent and the interaction with the user. The context may be used to generate recommended actions for the agent to take when interacting with the user in the application. In some implementations, the receiving the data model for the agent at operation 130 may include retrieving metadata to determine the context data. For example, the personalization context summarizer 206 that may be part of server 700 may retrieve metadata from data cloud metadata 210 as shown in FIG. 5. That is, the metadata may be used to assist in determining the one or more data sources, which may be used to generate context for the agent.

The server may generate a prompt to determine relevant information for the agent for the interaction by using an action and/or a directive for the agent based on the data model at operation 140, and the server may transmit the generated prompt to a large language model (LLM) system communicatively coupled to the server at operation 150. For example, the server 700 may transmit the generated prompt to LLM system 208 as shown in FIG. 5. The directive may be a set of instructions or guidelines that define how the agent should behave or perform specific actions within a system. That is, the directive may describe the purpose and/or decision-making process for the agent, which may allow the agent to autonomously complete tasks on behalf of a user or within the system, such as shown in FIG. 5. In some implementations of method 100, the server may receive agent configuration data, where the generating the prompt to determine relevant information for the agent at operation 140 is based on the received agent configuration data.

Providing the LLM system with sufficient information to make a decision may be difficult, since the data set involved may be large. In some implementations, the server may determine what parts of the data model are relevant by using Retrieval Augmented Generation (RAG). Rather than initially providing the LLM system with the entire data model, one implementation may pre-process the data model and use a semantic search to find a focused set of candidate information. This information may be used by the LLM system to refine and/or optimize the list.

At operation 160, the server may retrieve context data for one or more first objects from the one or more data sources based on a received response from the LLM system. For example, the server 700 may retrieve context data from data cloud 214 as shown in FIG. 5. That is, the LLM system provides a list of data sources for context data, and the server may retrieve data objects from the list of data sources to form the context data for the agent. In some implementations, the retrieved context data for the one or more first objects may be cached at a cache memory that is communicatively coupled to the server. For example, the context data may be cached with relevant context cache 212 that is communicatively coupled to the server 700 via communications network 600 as shown in FIG. 5.

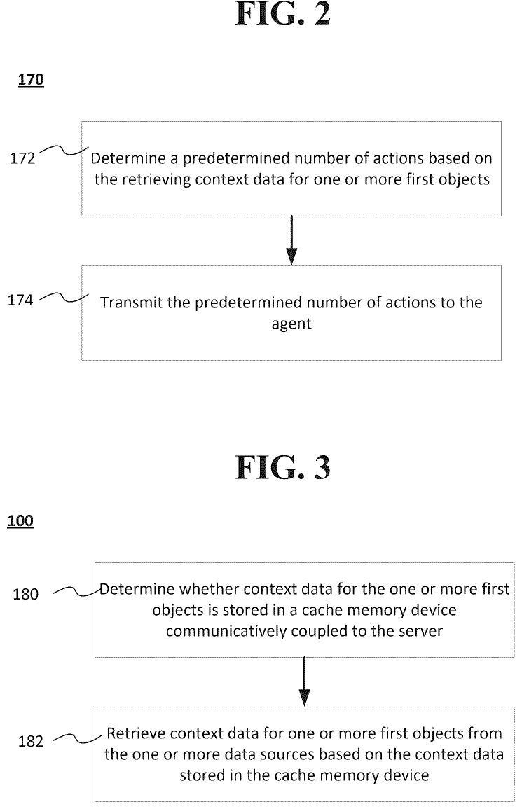

At operation 170, the server may determine at least a first action for the agent for the interaction based at least in part on the retrieved context data which is used as grounding. As shown in FIG. 2, the determining at least the first action at operation 170 may include that the server may determine a predetermined number of actions based on the retrieving context data for one or more first objects at operation 172, and transmit the predetermined number of actions to the agent at operation 174. For example, the number of predetermined actions may be three (3). The server may select the top three action for the agent to take based on the retrieved context data, and provide the top three actions to the agent. The number of predetermined actions being three is merely an example, and any suitable number of actions may be provided to the agent.

In some implementations, the method 100 may include the server determining at least a second action based on context data from one or more second objects when there is no data for the one or more first objects. That is, the server may determine a different action and/or group of actions for the agent based on a different set of objects when there is no data available for the first objects. This may allow the agent to have an alternative set of actions to be performed.

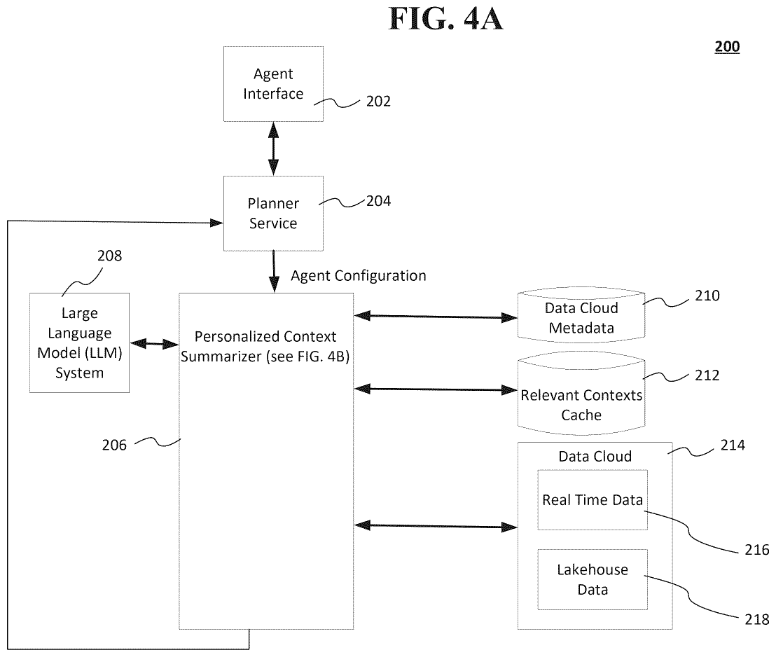

In some implementations, method 100 may include the additional operations shown in FIG. 3. At operation 180, the server may determine whether context data for the one or more first objects is stored in a cache memory device communicatively coupled to the server. At operation 182, the server may retrieve context data for one or more first objects from the one or more data sources based on the context data stored in the cache memory device.

The method 100 shown in FIGS. 1-3 may be performed by an example system and workflow of determining contextual information and agent actions shown in FIGS. 4A-4B according to implementations of the disclosed subject matter. An agent interface 202 may be part of an application that has one or more agents that may be provided by a server, such as server 700 shown in FIG. 5. The agent may be invoked by the application based on an interaction between the application and a user. Via the agent interface 202, a planner service 204 may be invoked by the agent to determine one or more actions to be taken by the agent. The planner service 204 may be part of the server 700 shown in FIG. 5, or may be on a separate server that is communicatively coupled to the communications network 600.

The planner service 204 may initiate a request to a personalization context summarizer 206. The planner service 204 may provide an agent configuration to the personalization context summarizer 206. The personalization context summarizer 206 may be part of the server 700 shown in FIG. 5, or may be on a separate server that is communicatively coupled to the communications network 600. The personalization context summarizer 206 may use data model loading module 220 shown in FIG. 4B to load a data model from data cloud metadata 210 to determine available information to be used to generate context for the interaction between the agent and the user.

Cache check 222 of the personalization context summarizer 206 may determine if a relevant contexts cache 212 includes the data model already. If the data model is already stored in the relevant contexts cache 212, the fetch contextual data module 230 may retrieve contextual data from a data cloud 214 communicatively coupled to the server. If not, prompt composition module 224 may collect available data and generate a prompt to be transmitted to LLM system 208. The LLM system 208 may determine the information that is likely to be relevant to the agent, based on a set of actions performable by the agent and based on directives. The cache relevance information module 228 may cache the ranking of object relevance (e.g., relevance of objects of the retrieved contextual data) at relevant context cache 212.

Based on the response received by the personalization context summarizer 206 from the LLM system 208, the personalization context summarizer 206 may retrieve the relevant data from data cloud 214, which may include real time data 216 and/or lakehouse data 218. The real time data 216 may include Real-time data is information that is available immediately after it is collected and/or processed. The lakehouse data 218 may have a data management architecture that combines the flexibility, cost-efficiency, and/or scale of data lakes with the data management and transactions of data warehouses, enabling business intelligence (BI) and machine learning (ML) on the data.

When no data is available for the objects identified (e.g., the one or more first objects described above in connection with FIGS. 1-3), personalization context summarizer 206 may determine the next best set of objects (e.g., the one or more second objects described above in connection with FIGS. 1-3).

The context data output from the personalization context summarizer 206 may be provided to the planner service 204, which may use the context data as grounding when selecting the one or more best actions for the agent to perform.

In some implementations, the personalization context summarizer 206 may describe at least a portion of the data model to the LLM system 208 along with the actions available, and based upon the LLM system 208 response, fetch the appropriate subsets of information from the profile. For example, personalization context summarizer 206 may describe a subset of the data cloud data model, such as parts of the data cloud data model available in real time.

In an example, a user (e.g., using computing device 500 shown in FIG. 5) may interact with an application that is directed to vehicle servicing and new vehicle sales that may be executed by and/or may communicate with server 700 shown in FIG. 5. Based on the interaction, the agent interface 202 of FIG. 4A may communicate with planner service 204 to determine how to best respond based on the user and interactions with the user. The planner service may communicate with personalized context summarizer 206 to retrieve a data model (e.g., from data could metadata 210) to determine what information may be available to use to generate context. In this example, the data model may represent what is known about a user, which may include: cars owned, vehicle service records, vacations taken, household makeup/composition, and/or general marketing interests. In this example, an agent of the application may be configured with a plurality of actions: booking vehicle service, checking on the status of existing service appointments, connecting the user with a vehicle service agent and/or sales agent. This may be based on the agent configuration information transmitted from the planner service 204 to the personalized context summarizer 206. The prompt composition module 224 of the personalized context summarizer 206 may generate a prompt based on the agent configuration and the available data may be provided to the LLM system 208 to determine a top N most likely relevant data points. That is, the contextual data may be retrieved from data cloud 214 based on the response from the LLM system, and the top N most likely relevant data points may be determined and provided to the planner service 204 and/or the agent via the agent interface 202.

Implementations of the disclosed subject matter may be implemented in and used with a variety of component and network architectures. FIG. 5 is an example computer 500 may allow a user to interact with the server 700 (or one or more other servers communicatively coupled to communications network 600) that is suitable for the operations detailed in FIGS. 1-3, and which may include system 200 shown in FIGS. 4A-4B. Although one server 700 is shown in FIG. 5, there may be a plurality of servers communicatively coupled to communications network 600 to perform the operations detailed in FIGS. 1-3 and the workflow of FIGS. 4A-4B. The computer 500 may be a single computer in a network of multiple computers.

In some implementations, the computer 500 may communicate with and may be used to receive one or more responses generated by server 700, database 710, large language model (LLM) system 208, data cloud metadata 210, relevant contexts cache 212, and/or data cloud 214 (e.g., which may include real time date 216 and/or lakehouse data 218) via communications network 600. The server 700 and/or LLM system 208 may be one or more hardware servers, virtual machines, cloud servers, databases, clusters, application servers, neural network systems, processors, devices, computers, or the like. The database 710, data cloud metadata 210, relevant contexts cache 212, and/or the data cloud 214 may use any suitable combination of any suitable volatile and non-volatile physical storage mediums, including, for example, hard disk drives, solid state drives, optical media, flash memory, tape drives, registers, and random access memory, or the like, or any combination thereof. The database 710 may store data, such as tenant data for an application, user data, user profile data, metadata, application data, and the like.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks. The service resource 404 and/or one or more user devices 750 may have components that are similar to the computer 500 described above.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 5 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “invoking”, “determining”, “receiving”, “generating”, “transmitting”, “retrieving”, “caching”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

In various implementations, the models and/or modules described herein may be classification, predictive, generative, conversational, or another form of artificial intelligence (AI) technology, such as AI model(s), agents, large language models (LLMs), etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
invoking, at a server, an agent based on an interaction with a user of an application; and
determining, at the server, an action to be taken by the agent based on the interaction with the user by:
receiving a data model for the agent to determine one or more data sources to generate context for the user interaction;
generating a prompt to determine relevant information for the agent for the interaction based on at least one selected from a group consisting of: an action for the agent based on the data model, and a directive for the agent based on the data model;
transmitting the generated prompt to a large language model (LLM) system communicatively coupled to the server;
retrieving context data for one or more first objects from the one or more data sources based on a received response from the LLM system based on the transmitted prompt; and
determining at least a first action for the agent for the interaction based at least in part on the retrieved context data which is used as grounding.

2. The method of claim 1, further comprising:
determining at least a second action based on context data from one or more second objects when there is no data for the one or more first objects.

3. The method of claim 1, wherein the receiving the data model for the agent further comprises retrieving metadata to determine the context data.

4. The method of claim 1, wherein the determining at least the first action comprises:
determining a predetermined number of actions based on the retrieving context data for one or more first objects; and
transmitting the predetermined number of actions to the agent.

5. The method of claim 1, further comprising:
receiving, at the server, agent configuration data, wherein the generating the prompt to determine relevant information for the agent is based on the received agent configuration data.

6. The method of claim 1, further comprising:
caching, at a cache memory communicatively coupled to the server, the retrieved context data for the one or more first objects.

7. The method of claim 1, further comprising:
determining whether context data for the one or more first objects is stored in a cache memory device communicatively coupled to the server; and
retrieving context data for one or more first objects from the one or more data sources based on the context data stored in the cache memory device.

8. A system comprising:
a server including at least one hardware processor coupled to a cache memory device, the server configured to:
invoke an agent based on an interaction with a user of an application; and
determine an action to be taken by the agent based on the interaction with the user by:
receiving a data model for the agent to determine one or more data sources to generate context for the user interaction;
generating a prompt to determine relevant information for the agent for the interaction based on at least one selected from a group consisting of: an action for the agent based on the data model, and a directive for the agent based on the data model;
transmitting the generated prompt to a large language model (LLM) system communicatively coupled to the server;
retrieving context data for one or more first objects from the one or more data sources based on a received response from the LLM system based on the transmitted prompt; and
determining at least a first action for the agent for the interaction based at least in part on the retrieved context data which is used as grounding.

9. The system of claim 1, wherein the server is configured to determine at least a second action based on context data from one or more second objects when there is no data for the one or more first objects.

10. The system of claim 9, wherein the server is configured to receive the data model for the agent by retrieving metadata to determine the context data.

11. The system of claim 9, wherein the server is configured to determine at least the first action by determining a predetermined number of actions based on the retrieving context data for one or more first objects, and transmitting the predetermined number of actions to the agent.

12. The system of claim 9, wherein the server is configured to receive an agent configuration data, wherein the generating the prompt to determine relevant information for the agent is based on the received agent configuration data.

13. The system of claim 9, wherein the server is configured to cache the retrieved context data for the one or more first objects at the cache memory device.

14. The system of claim 9, wherein the server is configured to determine whether context data for the one or more first objects is stored in a cache memory device communicatively coupled to the server, and retrieve context data for one or more first objects from the one or more data sources based on the context data stored in the cache memory device.
